(19) United States
(12) Patent Application Publication
(10) Pub. No.: US 2010/0241418 A1
(43) Pub. Date: Sep. 23, 2010

(54) VOICE RECOGNITION DEVICE AND VOICE RECOGNITION METHOD, LANGUAGE MODEL GENERATING DEVICE AND LANGUAGE MODEL GENERATING METHOD, AND COMPUTER PROGRAM

(75) Inventors: Yoshinori Maeda, Kanagawa (JP); Hitoshi Honda, Kanagawa (JP); Katsuki Minamino, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/661,164

(22) Filed: Mar. 11, 2010

(30) Foreign Application Priority Data
Mar. 23, 2009 (JP) P2009-070992

(51) Int. Cl. G10L 15/18; G06F 17/27; G10L 15/00

(52) U.S. Cl. 704/9; 704/257; 704/246; 704/E15.001; 704/E15.018

(57) ABSTRACT

A speech recognition device includes one intention extracting language model and more in which an intention of a focused specific task is inherent, an absorbing language model in which any intention of the task is not inherent, a language score calculating section that calculates a language score indicating a linguistic similarity between each of the intention extracting language model and the absorbing language model, and the content of an utterance, and a decoder that estimates an intention in the content of an utterance based on a language score of each of the language models calculated by the language score calculating section.

### BACKGROUND OF THE INVENTION

1. Field of the Invention

The present invention relates to a speech recognition device and a speech recognition method, a language model generation device and a language model generation method, and a computer program for recognizing the content of an utterance of a speaker, and particularly, a speech recognition device and a speech recognition method, a language model generation device and a language model generation method, and a computer program for estimating an intention of a speaker and grasping a task that a system is made to perform by a speech input.

To put more precisely, the present invention relates to a speech recognition device and a speech recognition method, a language model generation device and a language model generation method, and a computer program for accurately estimating an intention in the content of an utterance by using a statistical language model, and particularly, a speech recognition device and a speech recognition method, a language model generation device and a language model generation method, and a computer program for accurately estimating an intention for a focused task based on the content of an utterance.

2. Description of the Related Art

A language that human beings use in daily communication, such as Japanese or English language, is called a “natural language”. Many natural languages originated from spontaneous generation, and have advanced with the histories of mankind, ethnic groups, and societies. Of course, human beings can communicate with each other through gestures of their bodies and hands, but achieve the most natural and advanced communication with natural language.

On the other hand, accompanying the development of information technologies, computers are settled in human societies, and have deeply penetrated in various industries and our daily lives. Natural language inherently has characteristics of being highly abstract and ambiguous, but can be subjected to a computer processing by mathematically dealing with sentences, and as a result, various kinds of applications and services relating to natural language are realized.

As an application system of a natural language processing, speech understanding or speech conversation can be exemplified. For example, when a speech-based computer interface is constructed, speech understanding or speech recognition is a vital technique for realizing input from a human being to a calculator.

Here, speech recognition aims at converting the content of an utterance to characters as they are. On the contrary, speech understanding aims at more precisely estimating the intention of a speaker and grasping the task that the system is made to perform by speech input without accurately understanding each syllable or each word in the speech. However, in the present specification, speech recognition and speech understanding together are called “speech recognition” for the sake of convenience.

Hereinafter, procedures of speech recognition processing will be briefly described.

An input speech from a speaker is taken as an electronic signal through, for example, a microphone, subjected to AD conversion, and is turned into speech data constituted by a digital signal. In addition, in a signal processing section, a string X of temporal feature vectors is generated by applying acoustic analysis to the speech data for each frame of a slight time.

Next, a string of word models is obtained as a recognition result while referring to an acoustic model database, a lexicon, and a language model database.

An acoustic model recorded in an acoustic model database is, for example, a hidden Markov model (HMM) for a phoneme of the Japanese language. With reference to the acoustic model database, a probability p (X|W) in which input speech data X is a word W registered in a lexicon can be obtained as an acoustic score. Furthermore, in a language model database, for example, a word sequence ratio (N-gram) that describes how N number of words form a sequence is recorded. With reference to the language model database, an appearance probability p(W) of the word W registered in the lexicon can be obtained as a language score. Moreover, a recognition result can be obtained based on the acoustic score and the language score.

Here, as a language model used in the computation of the language score, a descriptive grammar model and a statistical language model can be exemplified. The descriptive grammar model is a language model that describes a structure of a phrase in a sentence according to grammar rules, and described by using context-free grammar in the Backus-Naur-Form (BNF), as shown in FIG. 10, for example. In addition, the statistical language model is a language model that is subjected to probability estimation from a learning data (corpus) with a statistical technique. For example, an N-gram model causes a probability p (Wᵢ|W₁, . . . , Wᵢ₋₁) in which a word Wᵢ appears in the order of i-th after an (i−1)-th word appears in the order of W₁, . . . , and Wᵢ₋₁ to approximate to the sequence ratio p of the nearest N number of words (Wᵢ|W_{i-N+1}, . . . , Wᵢ₋₁) (please refer to, for example, “Speech Recognition System” (“Statistical Language Model” in Chapter 4) written by Kiyohiro Shikano and Katsunobu Ito, pp. 53 to 69, published by Ohmsha, Ltd., May 15, 2001, first edition, ISBN 4-274-13228-5)

The descriptive grammar model is basically created manually, and recognition accuracy is high if the input speech data conforms to the grammar, but the recognition is not able to be achieved if the data fail to conform to the grammar even by only a little. On the other hand, the statistical language model represented in the N-gram model can be automatically created by subjecting the learning data to a statistical processing, and furthermore, can recognize the input speech data even if the arrangement of words in the input speech data runs slightly counter to the grammar rules.

Furthermore, in creating the statistical language model, a large amount of learning data (corpus) is necessary. As methods of collecting the corpus, there are general methods such as collecting the corpus from media including books, newspapers, magazines, or the like and collecting the corpus from texts disclosed on web sites.

In a speech recognition processing, expressions uttered by a speaker are recognized by a word and a phrase. However, in many application systems, it is more important to accurately estimate the intention of the speaker than to accurately understand all syllables and words in the speech. To add further, when the content of an utterance is not relevant to a task focused in speech recognition, it is not necessary to fit any intention of a task to the recognition by force. If an intention that is erroneously estimated is output, there is even a concern that may cause a wasteful operation in which the system provides the user with irrelevant tasks.

There are various ways of uttering even for one intention. For example, in the task of “operate the television”, there is a plurality of intentions such as “switch the channel”, “watch a program”, and “turn up the volume”, but there is a plurality of ways of uttering for each of the intentions. For example, in the intention to switch the channel (to NHK), there are two or more ways of uttering such as “please switch to NHK” and “to NHK”, in the intention to watch a program (Taiga Drama: a historical drama), there are two or more ways of uttering, such as “I want to watch Taiga Drama” and “Turn on the Taiga Drama”, and in the intention to turn up the volume, there are two or more ways of uttering, such as “raise the volume” and “volume up”.

For example, a speech processing device was suggested in which a language model is prepared for each intention (information on wishes) and an intention corresponding to the highest total score is selected as information indicating a wish of uttering based on an acoustic score and a language score (for example, please refer to Japanese Unexamined Patent Application Publication No. 2006-53203).

The speech processing device uses each statistical language model as a language model for intentions, and recognizes the intentions even when the arrangement of words in input speech data runs slightly counter to grammar rules. However, even when the content of an utterance does not correspond to any intention of a focused task, the device fits any intention to the content by force. For example, when the speech processing device is configured to provide the service of a task relating to a television operation and provided with a plurality of statistical language models in which each intention relating to the television operation is inherent, an intention corresponding to a statistical language model showing a high value of a calculated language score is output as a recognition result even for the content of an utterance that does not intend a television operation. Accordingly, it ends up with the result of extracting an intention different from the intended content of the utterance.

Furthermore, in configuring the speech processing device in which individual language models are provided for intentions as described above, it is necessary to prepare a sufficient number of language models for extracting the intentions of a task in consideration of the content of an utterance according to a focused specific task. In addition, it is necessary to collect learning data (corpus) according to intentions for creating robust language models for the intentions in a task.

There is a general method of collecting the corpus from media such as books, newspapers, and magazines, and texts on web sites. For example, a method of generating a language model was suggested which generates a symbol sequence ratio with high accuracy by putting heavier importance on a text nearer to a recognition task (the content of an utterance) in an enormous text database, and improves the recognition capability by using the ratio in the recognition (for example, please refer to Japanese Unexamined Patent Application Publication No. 2002-82690).

However, even if an enormous amount of learning data can be collected from the media such as books, newspapers, and magazines, and texts on web sites, selecting a phrase that a speaker is likely to utter takes effort and having a huge number of corpuses completely consistent with the intention is difficult. In addition, it is difficult to specify an intention of each text or to classify a text by intention. In other words, a corpus completely consistent with the intention of a speaker may not be collected.

The inventors of the present invention consider that it is necessary to solve the following two points in order to realize a speech recognition device that accurately estimates an intention relating to a focused task in the content of an utterance.

(1) A corpus having content that a speaker is likely to utter is simply and appropriately collected for each intention.

(2) Any intention is not forced to fit to the content of an utterance, which is inconsistent with a task, but rather ignored.

### SUMMARY OF THE INVENTION

It is desirable to provide a speech recognition device and a speech recognition method, a language model generation device and a language model generation method, and a computer program which are excellent in estimating the intention of a speaker, and accurately grasping a task that the system is made to perform by a speech input.

It is more desirable to provide a speech recognition device and a speech recognition method, a language model generation device and a language model generation method, and a computer program which are excellent in accurately estimating an intention of the content of an utterance by using a statistical language model.

It is still more desirable to provide a speech recognition device and a speech recognition method, a language model generation device and a language model generation method, and a computer program, which are excellent in accurately estimating the intention relating to a task focused in the content of an utterance.

The present invention takes into consideration the above matters, and according to a first embodiment of the present invention, a speech recognition device includes one intention extracting language model and more in which each intention of a focused specific task is inherent, an absorbing language model in which any intention of the task is not inherent, a language score calculating section that calculates a language score indicating a linguistic similarity between each of the intention extracting language models and the absorbing language model, and the content of an utterance, and a decoder that estimates an intention in the content of an utterance based on a language score of each of the language models calculated by the language score calculating section.

According to a second embodiment of the present invention, there is provided a speech recognition device in which the intention extracting language model is a statistical language model obtained by subjecting learning data, which are composed of a plurality of sentences indicating the intention of the task, to a statistical processing.

Furthermore, according to a third embodiment of the present invention, there is provided a speech recognition device in which the absorbing language model is a statistical language model obtained by subjecting to statistical processing an enormous amount of learning data, which are irrelevant to indicating the intention of the task or are composed of spontaneous utterances.

Furthermore, according to a fourth embodiment of the present invention, there is provided a speech recognition device in which the learning data for obtaining the intention extracting language model are composed of sentences which are generated based on a descriptive grammar model indicating a corresponding intention and consistent with the intention.

Furthermore, according to a fifth embodiment of the present invention, there is provided a speech recognition method including the steps of firstly calculating a language score indicating a linguistic similarity between one intention extracting language model and more in which each intention of a focused specific task is inherent and the content of an utterance, secondly calculating a language score indicating a linguistic similarity between an absorbing language model in which any intention of the task is not inherent and the content of an utterance, and estimating the intention in the content of an utterance based on a language score of each of the language models calculated in the first and second language score calculations.

Furthermore, according to a sixth embodiment of the present invention, there is provided a language model generation device including a word meaning database in which a combination of an abstracted vocabulary of a first part-of-speech string and an abstracted vocabulary of a second part-of-speech string and one or more words indicating the same meaning or a similar intention of the abstracted vocabularies are registered, by making abstract the vocabulary candidate of the first part-of-speech string and the vocabulary candidate of the second part-of-speech string that may appear in an utterance indicating an intention, with respect to each intention of a focused specific task, a descriptive grammar model creating unit which creates a descriptive grammar model indicating an intention based on the combination of the abstracted vocabulary of the first part-of-speech string and the abstracted vocabulary of the second part-of-speech string indicating the intention of the task and one or more words indicating a same meaning or a similar intention for abstract vocabularies registered in the word meaning database, a collecting unit which collects a corpus having content that a speaker is likely to utter for an intention by automatically generating sentences consistent with each intention from the descriptive grammar model for the intention, and a language model creating unit that creates a statistical language model in which each intention is inherent by subjecting the corpus collected for the intention to statistical processing.

However, the specific example of the first part-of-speech mentioned here is a noun and the specific example of the second part-of-speech mentioned here is a verb. To put simply, it would be better to make understood that a combination of important vocabularies indicating an intention is referred to as the first part-of-speech or the second part-of-speech.

According to a seventh embodiment of the present invention, there is provided the language model generation device in which the word meaning database has the abstracted vocabulary of the first part-of-speech string and the abstracted vocabulary of the second part-of-speech string arranged on a matrix for each string and has a mark indicating the existence of the intention given in a column corresponding to the combination of the vocabulary of the first part-of-speech and the vocabulary of the second part-of-speech having intentions.

Furthermore, according to an eighth embodiment of the present invention, there is provided a language model generation method including the steps of creating a grammar model by making abstract a necessary phrase for transmitting each intention included in a focused task, collecting a corpus having content that a speaker is likely to utter for an intention by automatically generating sentences consistent with each intention by using the grammar model, and constructing a plurality of statistical language models corresponding to each intention by performing probabilistic estimation from each corpus with a statistical technique.

Furthermore, according to a ninth embodiment of the present invention, there is provided a computer program described in a computer readable format so as to execute a processing for speech recognition on a computer, the program causing the computer to function as one intention extracting language model and more in which each intention of a focused specific task is inherent, an absorbing language model in which any intention of the task is not inherent, a language score calculating section that calculates a language score indicating a linguistic similarity between each of the intention extracting language model and the absorbing language model, and the content of an utterance, and a decoder that estimates an intention in the content of an utterance based on a language score of each of the language models calculated by the language score calculating section.

The computer program according to the above embodiment of the present invention is defined as a computer program that is described in a computer readable format so as to realize a predetermined processing on the computer. In other words, by installing the computer program according to the embodiment of the present invention on a computer, a cooperative action can be exerted on the computer and the same action and effect as in a speech recognition device according to the first embodiment of the present invention can be obtained.

Furthermore, according to a tenth embodiment of the present invention, there is provided a computer program described in a computer readable format so as to execute processing for the generation of a language model on a computer, the program causing the computer to function as a word meaning database in which a combination of an abstracted vocabulary of a first part-of-speech string and an abstracted vocabulary of a second part-of-speech string and one or more words indicating the same meaning or a similar intention of the abstracted vocabularies are registered, by making abstract the vocabulary candidate of the first part-of-speech string and the vocabulary candidate of the second part-of-speech string that may appear in an utterance indicating an intention, with respect to each intention of a focused specific task, a descriptive grammar model creating unit which creates a descriptive grammar model indicating an intention based on the combination of the abstracted vocabulary of the first part-of-speech string and the abstracted vocabulary of the second part-of-speech string indicating the intention of the task and one or more words indicating a same meaning or a similar intention for abstracted vocabularies registered in the word meaning database, a collecting unit which collects a corpus having a content that a speaker is likely to utter for an intention by automatically generating sentences consistent with each intention from the descriptive grammar model for the intention, and a language model creating unit that creates a statistical language model in which each intention is inherent by subjecting the corpus collected for the intention to statistical processing.

The computer program according to the above embodiment of the present invention is defined as a computer program that is described in a computer readable format so as to realize a predetermined processing on the computer. In other words, by installing the computer program according to the embodiment of the present invention on a computer, a cooperative action can be exerted on the computer and the same action and effect as in the language model generation device according to the sixth embodiment of the present invention can be obtained.

According to the present invention, it is possible to provide a speech recognition device and a speech recognition method, a language model generation device and a language model generation method, and a computer program which are excellent in estimating an intention of a speaker, and accurately grasping a task that a system is made to perform by a speech input.

Furthermore, according to the present invention, it is possible to provide a speech recognition device and a speech recognition method, a language model generation device and a language model generation method, and a computer program which are excellent in accurately estimating an intention of the content of an utterance by using a statistical language model.

Furthermore, according to the present invention, it is possible to provide a speech recognition device and a speech recognition method, a language model generation device and a language model generation method, and a computer program which are excellent in accurately estimating an intention relating to a task focused in the content of an utterance.

According to the first to fifth, and ninth embodiments of the present intention, it is possible to realize robust intention extraction for the task, by being provided with a statistical language model corresponding to the content of an utterance that is inconsistent with a focused task, such as a spontaneous utterance language model or the like, in addition to a statistical language model in which an intention included in a focused task is inherent, by performing processing in parallel, and by ignoring the estimation of an intention in the content of an utterance that is inconsistent with the task.

According to the sixth to eighth, and tenth embodiments of the present invention, a corpus having a content that a speaker is likely to utter (in other words, a corpus necessary to create a statistical language model in which an intention is inherent) can be simply and appropriately collected for an intention by determining the intention included in a focused task in advance and automatically generating sentences consistent with the intention from a descriptive grammar model indicating the intention.

According to the seventh embodiment of the present invention, the content that is likely to be uttered can be grasped without the omission by arranging the vocabulary candidate of the noun string and the vocabulary candidate of the verb string that may appear in the utterance on a matrix for a string. In addition, since one or more words having the same meaning or a similar meaning are registered in symbols of the vocabulary candidates of each string, it is possible to come up with a combination corresponding to various expressions of an utterance having a same meaning and to generate a large amount of sentences having the same intention as the learning data.

If the collecting method for the learning data is employed according to the sixth to eighth, and tenth embodiment of the present invention, the corpus consistent with one focused task can be divided for each intention and can be simply and efficiently collected. Moreover, by creating the statistical language model from each of the created learning data, a group of language models in which one intention of the same task is inherent can be obtained. In addition, by using a morpheme interpreting software, part-of-speech and conjugation information are given to each morpheme to be used during the creation of the statistical language model.

According to the sixth and tenth embodiments of the present invention, it is configured to take procedures of creating the statistical language model, in which the collecting unit collects a corpus having a content that a speaker is likely to utter for each intention by automatically generating sentences consistent with each intention from the descriptive grammar model for the intention, and the language model creating unit creates the statistical language model in which an intention is inherent by subjecting the corpus collected for each intention to a statistical processing. In that sense, there are two advantages shown below.

(1) Uniformity of morphemes (division of words) is promoted. In a grammar model that is created manually, there is a high possibility that the uniformity of morphemes is not achievable. However, even if the morphemes are not united, it is possible to use united morphemes by using the morpheme interpreting software when the statistical language model is created.

(2) By using the morpheme interpreting software, information on parts of speech or conjugations can be obtained, and the information can be reflected during the creation of the statistical language model.

Another aim, characteristic, and advantage of the present invention will be clarified with detailed description based on embodiments of the present intention to be described below and accompanying drawings.

### BRIEF DESCRIPTION OF THE DRAWINGS

FIG. 1 is a block diagram schematically illustrating a functional structure of a speech recognition device according to an embodiment of the present invention;

FIG. 2 is a diagram schematically illustrating a the minimum necessary structure of phrases for transmitting an intention;

FIG. 3A is a diagram illustrating a word meaning database in which abstracted noun vocabularies and verb vocabularies are arranged in a matrix form;

FIG. 3B is a diagram illustrating a state in which words indicating a same meaning or a similar intention are registered for abstracted vocabularies;

FIG. 4 is a diagram for describing a method of creating a descriptive grammar model based on a combination of a noun vocabulary and a verb vocabulary put a mark in the matrix shown in FIG. 3A;

FIG. 5 is a diagram for describing a method of collecting a corpus having a content that a speaker is likely to utter by automatically generating sentences consistent with an intention from the descriptive grammar model for each intention;

FIG. 6 is a diagram illustrating a flow of data in a technique of constructing a statistical language model from a grammar model;

FIG. 7 is a diagram schematically illustrating a structural example of a language model database constituted with N number of statistical language models 1 to N learned for an intention of a focused task and one absorbing statistical language model;

FIG. 8 is a diagram illustrating an operative example when a speech recognition device performs meaning estimation for the task “Operate the television”;

FIG. 9 is a diagram illustrating a structural example of a personal computer provided in an embodiment of the present invention; and

FIG. 10 is a diagram illustrating an example of a descriptive grammar model described with the context-free grammar.

### DESCRIPTION OF THE PREFERRED EMBODIMENTS

The present invention relates to a speech recognition technology and has a main characteristic of accurately estimating an intention in content that a speaker utters focusing on a specific task, and thereby resolving the following two points.

(1) A corpus having content that a speaker is likely to utter is simply and appropriately collected for each intention.

(2) Any intention is not forced to fit to the content of an utterance, which is inconsistent with a task, but rather ignored.

Hereinbelow, an embodiment for resolving the two points will be described in detail with reference to accompanying drawings.

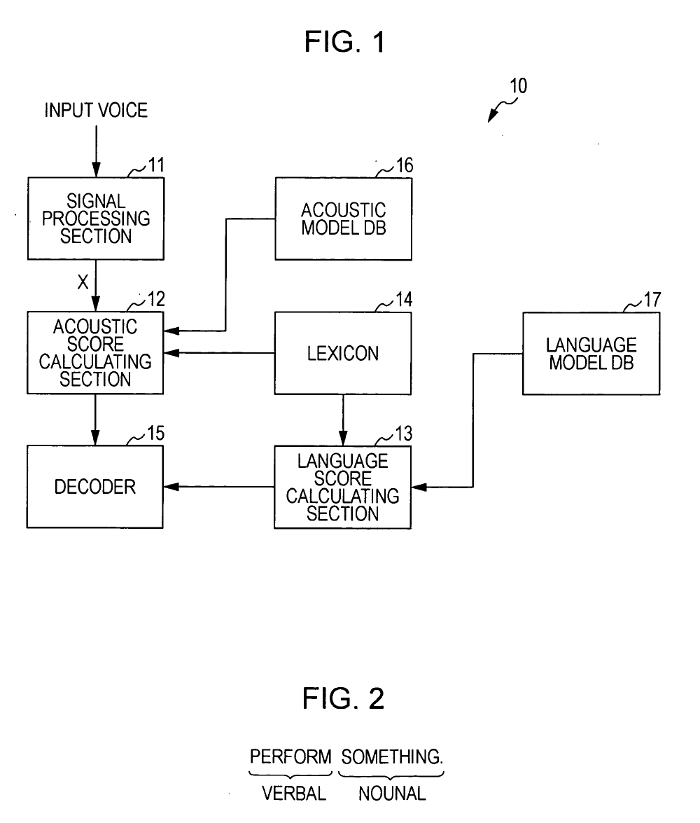

FIG. 1 schematically illustrates a functional structure of a speech recognition device according to an embodiment of the present invention. The speech recognition device 10 in the drawing is provided with a signal processing section 11, an acoustic score calculating section 12, a language score calculating section 13, a lexicon 14, and a decoder 15. The speech recognition device 10 is configured to accurately estimate an intention of a speaker, rather than to accurately understand all of syllable by syllable and word by word in speech.

Input speech from a speaker is brought into the signal processing section 11 as electric signals through, for example, a microphone. Such analog electric signals undergo AD conversion through sampling and quantization processing to turn into speech data constituted with digital signals. In addition, the signal processing section 11 generates a series X of temporal feature vector by applying acoustic analysis to the speech data for each frame of a slight time. By applying process of frequency analysis such as Discrete Fourier Transform (DFT) or the like as the acoustic analysis, for example, the series X of the feature vector, which has characteristics of, such as, energy for each frequency band (so called power spectrum) based on the frequency analysis is generated.

Next, a string of word models is obtained as a recognition result while referring to an acoustic model database 16, the lexicon 14, and a language model database 17.

The acoustic score calculating section 12 calculates an acoustic score indicating an acoustic similarity between an acoustic model including a string of words formed based on the lexicon 14 and input speech signals. The acoustic model recorded in the acoustic model database 16 is, for example, a Hidden Markov Model (HMM) for a phoneme of the Japanese language. The acoustic score calculating section 12 can obtain a probability p (X|W) in which the input speech data X is a word W registered in the lexicon 14 as an acoustic score while referring to the acoustic model database.

Furthermore, the language score calculating section calculates an acoustic score indicating a linguistic similarity between a language model including a string of words formed based on the lexicon 14 and input speech signals. In the language model database 17, the word sequence ratio (N-gram) that describes how N number of words form a sequence is recorded. The language score calculating section 13 can obtain an appearance probability p(W) of the word W registered in the lexicon 14 as a language score with reference to the language model database 17.

The decoder 15 obtains a recognition result based on the acoustic score and the language score. Specifically, as shown in Equation (1) below, if a probability p(W|X) in which the word W registered in the lexicon 14 is the input speech data X is calculated, the candidate words are searched and output in the order of having a high probability.

p(W|X)∝p(W)·p(X|W) (1)

In addition, the decoder 15 can estimate an optimal result with Equation (2) shown below.

W=arg max p(W|X) (2)

A language model that the language score calculating section 13 uses is the statistical language model. The statistical language model represented by the N-gram model can be automatically created from learning data and can recognize speech even when the arrangement of words in the input speech data runs counter to grammar rules a little. The speech recognition device 10 according to the present embodiment is assumed to estimate an intention relating to a task focused in the content of an utterance, and for that reason, the language model database 17 is installed with a plurality of statistical language models corresponding to each intention included in a focused task. In addition, the language model database 17 is installed with a statistical language model corresponding to the content of an utterance inconsistent with a focused task in order to ignore an intention estimation for the content of an utterance inconsistent with the task, which will be described in detail later.

There is a problem that constructing a plurality of statistical language models corresponding to each intention is difficult. The reason is because it takes effort to select out phrases that a speaker is likely to utter, even if an enormous amount of text data in media such as books, newspapers, magazines and the like, and on web sites can be collected, and it is difficult to have an enormous amount of corpuses for each intention. In addition, it is not easy to specify intentions in each text or to classify texts for each intention.

Therefore, the present embodiment makes it possible to simply and appropriately collect a corpus having content that a speaker is likely to utter for each intention and to construct statistical language models for each intention, by using a technique of constructing the statistical language models from a grammar model.

First, if an intention included in a focused task is determined in advance, the grammar model is efficiently created by making phrases necessary for transmitting the intention abstract (or symbolized). Next, by using the created grammar model, sentences consistent with each intention are automatically generated. As such, after collecting the corpus having the content that the speaker is likely to utter for each intention, the plurality of statistical language models corresponding to each intention can be constructed by performing a probability estimation from each corpus with a statistical technique.

Furthermore, for example, “Bootstrapping Language Models for Dialogue Systems” written by Karl Weilhammer, Matthew N. Stuttle, and Steve Young (Interspeech, 2006) describes the technique of constructing statistical language models from the grammar model, but made no mention of an efficient construction method. On the contrary, in the present embodiment, the statistical language models can be efficiently constructed from the grammar model as described below.

There will be described about a method of creating a corpus for each intention using the grammar model.

When a corpus for learning a language model in which any one intention is included is created, a descriptive grammar model is created for obtaining the corpus. The inventors think that a structure of a simple and short sentence that a speaker is likely to utter (or a minimum phrase necessary for transmitting an intention) is composed of a combination of a noun vocabulary and a verb vocabulary, as “PERFORM SOMETHING” (as shown in FIG. 2). Therefore, words for each of the noun vocabulary and the verb vocabulary are made to be abstract (or symbolized) in order to efficiently construct the grammar model.

For example, noun vocabularies indicating a title of a television program such as “Taiga Drama” (a historical drama) or “Waratte ii tomo” (a comedy program) are made abstract as a vocabulary “_Title”. In addition, verb vocabularies for machines used in watching programs such as a television, or the like, such as “please replay”, “please show”, or “I want to watch” are made to be abstract as the vocabulary “_Play”. As a result, the utterance having an intention of “please show the program” can be expressed by a combination of symbols for _Title & _Play.

Furthermore, words indicating a same meaning or a similar intention are registered, for example, as below for each of the abstracted vocabularies. The registering work may be done manually.

_Title=Taiga Drama, Waratte ii tomo, . . .

_Play=please replay, replay, show, please show, I want to watch, do it, turn on, play, . . .

In addition, “_Play the _Title”, or the like are created as the descriptive grammar model for obtaining corpuses. Corpuses such as “Please show the Taiga Drama” (historical drama) or the like can be created from the descriptive grammar model “_Play the _Title”.

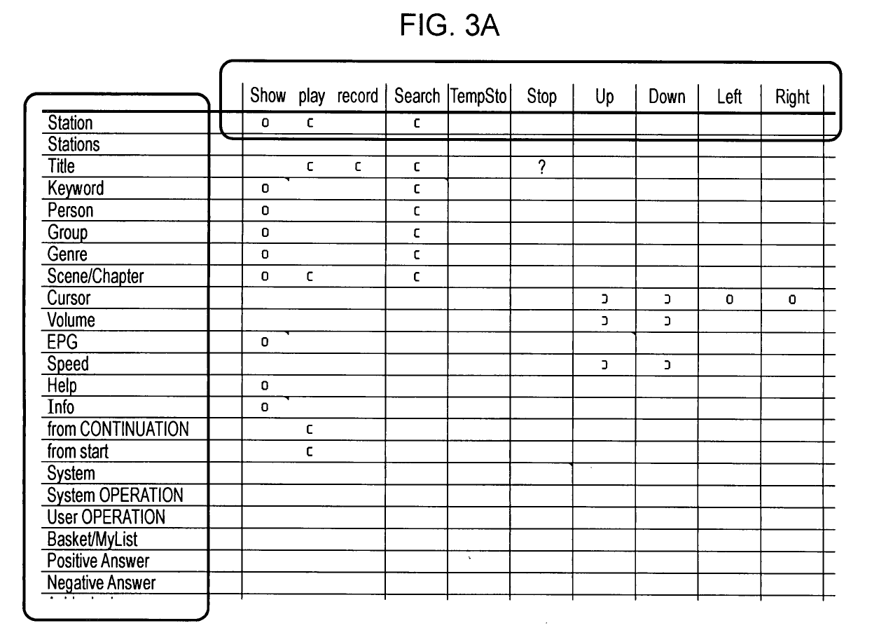

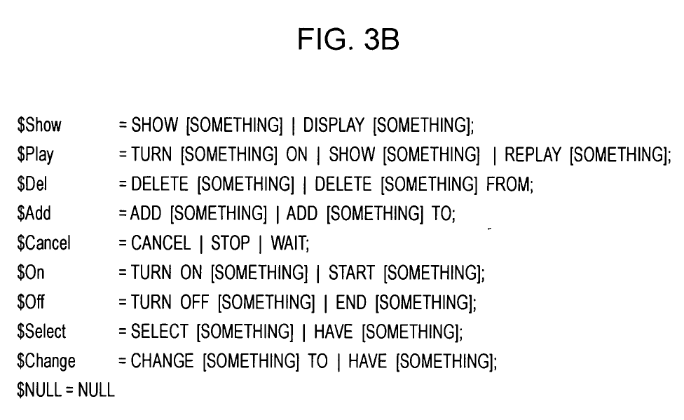

As such, the descriptive grammar models can be composed of the combination of each of the abstracted noun vocabularies and the verb vocabularies. In addition, the combination of each of the abstracted noun vocabularies and the verb vocabularies may express one intention. Therefore, as shown in FIG. 3A, a matrix is formed by arranging the abstracted noun vocabularies in each row and arranging the abstracted verb vocabularies in each column, and a word meaning database is constructed by putting a mark indicating the existence of an intention in a corresponding column on the matrix for the each of the combinations of abstracted noun vocabularies and the verb vocabularies having the intention.

In the matrix shown in FIG. 3A, a noun vocabulary and a verb vocabulary combined with a mark indicates a descriptive grammar model in which any one intention is included. In addition, words indicating the same meaning or a similar intention are registered in the word meaning database for the abstracted noun vocabularies divided with the rows in the matrix. Moreover, as shown in FIG. 3B, words indicating a same meaning or a similar intention are registered in the word meaning database for the abstracted verb vocabularies divided with the columns in the matrix. Furthermore, the word meaning database can be expanded into a three-dimensional arrangement, not a two-dimensional arrangement as the matrix shown in FIG. 3A.

There are advantages as follows in expressing the word meaning database that deals with the descriptive grammar models corresponding to each intention included in a task by making into a matrix as above.

(1) It is easy to confirm whether the contents of an utterance by a speaker are comprehensively included.

(2) It is easy to confirm whether functions of a system can be matched without omissions.

(3) It is possible to efficiently construct a grammar model.

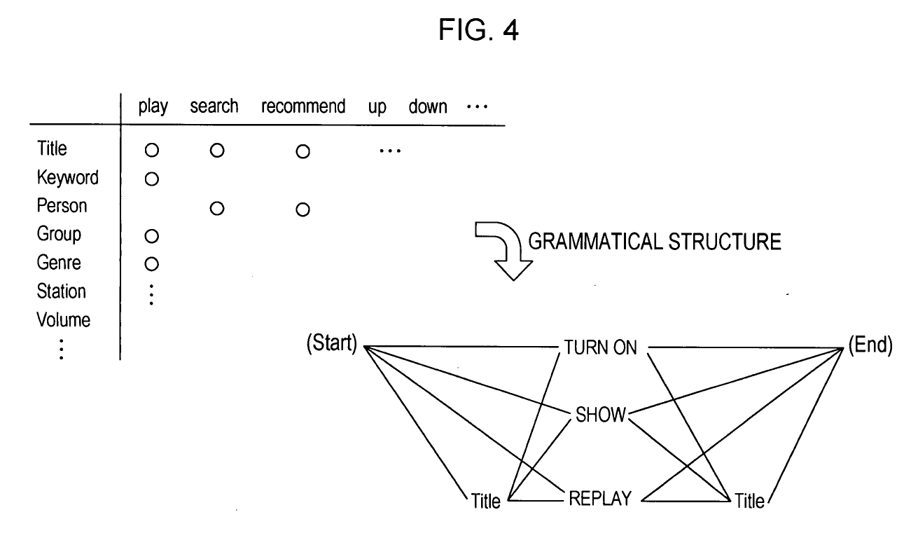

In the matrix shown in FIG. 3A, each of the combinations of the noun vocabularies and the verb vocabularies given with marks corresponds to a descriptive grammar model indicating an intention. In addition, if each of registered words indicating a same meaning or a similar intention is forced to fit to each of the abstracted noun vocabularies and the abstracted verb vocabularies, the descriptive grammar model described in the form of BNF can be efficiently created, as shown in FIG. 4.

With regard to one focused task, a group of language models specified to the task can be obtained by registering noun vocabularies and verb vocabularies that may appear when a speaker makes an utterance. In addition, each of the language models has one intention (or operation) inherent therein.

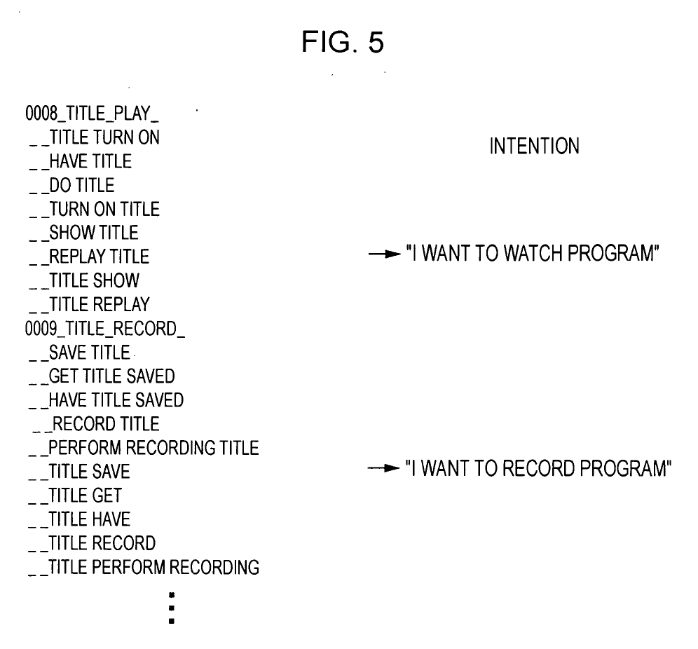

In other words, from the descriptive grammar models for each intention that are obtained from the word meaning database in the form of matrix shown in FIG. 3A, corpuses having content that a speaker is likely to utter can be collected for each intention by automatically generating sentences consistent with the intention as shown in FIG. 5.

A plurality of statistical language models corresponding to each intention can be constructed by performing a probability estimation from each corpus with a statistical technique. A method of constructing the statistical language models from each corpus is not limited to any specific method, and since a known technique can be applied thereto, detailed description thereof will not be mentioned here. The “Speech Recognition System” written by Kiyohiro Shikano and Katsunobu Ito mentioned above may be referred, if necessary.

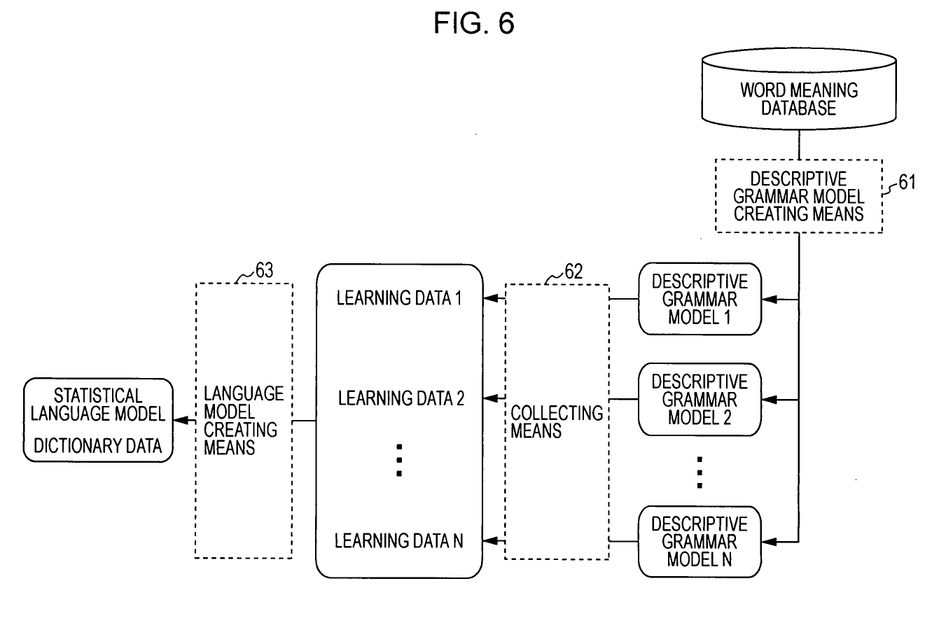

FIG. 6 illustrates a flow of data in a method of constructing a statistical language model from a grammar model, which has been described hitherto.

The structure of the word meaning database is as shown in FIG. 3A. In other words, noun vocabularies relating to a focused task (for example, operation of a television, or the like) are made into each group indicating a same meaning or a similar intention, and the noun vocabularies that are made into each abstracted group are arranged in each row of the matrix. In the same way, verb vocabularies relating to a focused task are made into each group indicating a same meaning or a similar intention, and the verb vocabularies that are made into each abstracted group are arranged in each column of the matrix. In addition, as shown in FIG. 3B, a plurality of words indicating same meanings or similar intentions is registered for each of the abstracted noun vocabularies and a plurality of words indicating same meanings or similar intentions is registered for each of the abstracted verb vocabularies.

On the matrix shown in FIG. 3A, a mark indicating the existence of an intention is given in a column corresponding to a combination of a noun vocabulary and a verb vocabulary having the intention. In other words, each of the combinations of noun vocabularies and verb vocabularies matched with marks corresponds to a descriptive grammar model indicating an intention. A descriptive grammar model creating unit 61 picks up a combination of an noun vocabulary and an abstracted vocabulary indicating an intention having a mark on the matrix as a clue, then forces to fit each registered word indicating a same meaning or a similar intention to each of abstracted noun vocabularies and abstracted verb vocabularies, and creates a descriptive grammar model in the form of BNF to store the model as a file of the context-free grammar. Basic files of the BNF form are automatically created, and then the model will be modified in the form of a BNF file according to the expression of an utterance. In the example shown in FIG. 6, the N number of descriptive grammar models from 1 to N are constructed by the descriptive grammar model creating unit 61 based on the word meaning database, and stored as files of the context-free grammar. In the present embodiment, the BNF form is used in defining the context-free grammar, but the spirit of the present invention is not necessarily limited thereto.

A sentence indicating a specific intention can be obtained by creating a sentence from a created BNF file. As shown in FIG. 4, transcription of a grammar model in the BNF form is a sentence creation rule from a non-terminal symbol (Start) to a terminal symbol (End). Therefore, collecting unit 62 can automatically generate a plurality of sentences indicating same intentions as shown in FIG. 5 and can collect corpuses having a content that a speaker is likely to utter for each intention by searching a route from the non-terminal symbol (Start) to the terminal symbol (End) for a descriptive grammar model indicating an intention. In the example shown in FIG. 6, the group of sentences automatically generated from each of the descriptive grammar models is used as learning data indicating the same intention. In other words, learning data 1 to N collected for each intention by the collecting unit 62 become corpuses for constructing statistical language models.

As such, it is possible to obtain descriptive grammar models by focusing on parts of nouns and verbs forming a meaning in a simple and short utterance, and symbolizing each of them. In addition, since a sentence indicating a specific meaning in a task is generated from the descriptive grammar model in the BNF form, corpuses necessary for creating statistical language models in which intentions are inherent can be simply and efficiently collected.

Moreover, the language model creating unit 63 can construct a plurality of statistical language models corresponding to each intention by performing a probability estimation for corpuses of each intention with a statistical technique. The sentence generated from the descriptive grammar model in the BNF form indicates a specific intention in a task, and therefore, a statistical language model created using a corpus including the sentence can be said as a robust language model in the content of an utterance for the intention.

Furthermore, the method of constructing a statistical language model from a corpus is not limited to any specific method, and since a known technique can be applied, detailed description thereof will not be mentioned here. The “Speech Recognition System” written by Kiyohiro Shikano and Katsunobu Ito mentioned above may be referred, if necessary.

In the descriptions hitherto, it can be understood that a corpus having a content that a speaker is likely to utter is simply and appropriately collected for each intention and a statistical language model for each intention can be constructed by using a technique of constructing the statistical language model from a grammar model.

Consecutively, there will be provided a description of a method in which any intention is not forced to fit to the content of an utterance inconsistent with a task, but can be ignored in the speech recognition device.

When a speech recognition processing is performed, the language score calculating section 13 calculates a language score from a group of language models created for each intention, the acoustic score calculating section 12 calculates an acoustic score with an acoustic model, and the decoder 15 employs the most likely language model as a result of speech recognition processing. Accordingly, it is possible to extract or estimate the intention of an utterance from information for identifying the language model selected for the utterance.

When the group of language models that the language score calculating section 13 uses is composed only of language models created for an intention in a focused specific task, utterance irrelevant to the task may be forced to fit to any language model and the model may be output as a recognition result. Accordingly, it ends up with a result of extracting an intention different from the content of the utterance.

Therefore, in a speech recognition device according to the preset embodiment, an absorbing statistical language model corresponding to the content of an utterance inconsistent with a task is provided in the language model database 17 in addition to statistical language models for each intention in a focused task, and the group of statistical language models in the task is processed in tandem with the absorbing statistical language model, in order to absorb the content of an utterance not indicating any intention in the focused task (in other words, irrelevant to the task).

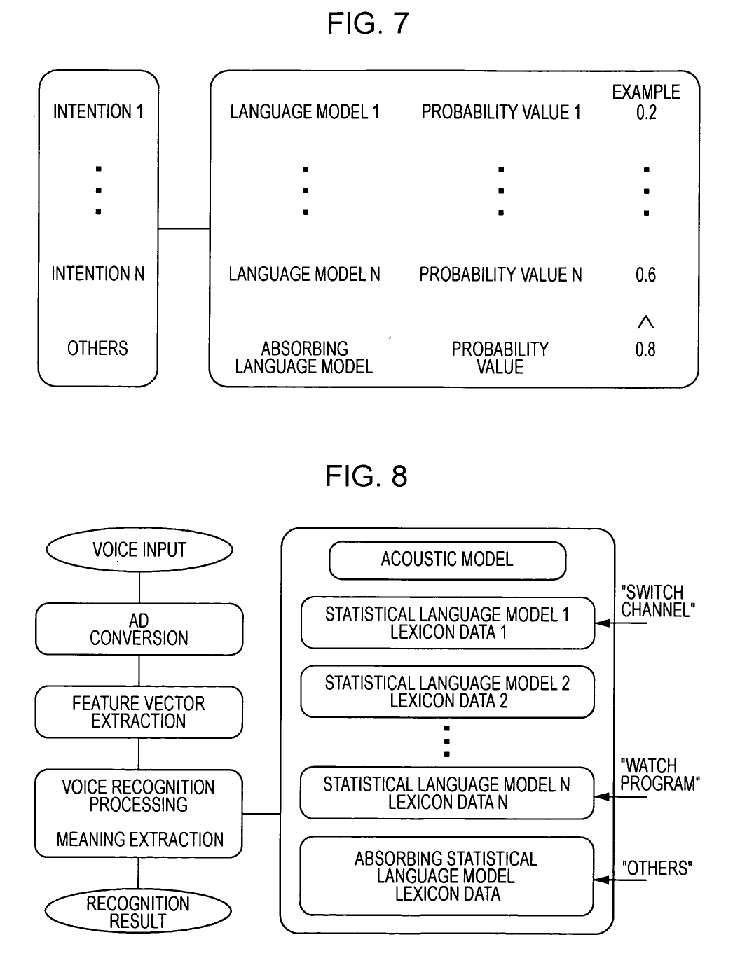

FIG. 7 schematically illustrates the structural example of N number of the statistical language models 1 to N learned corresponding to each intention in a focused task and the language model database 17 including one absorbing statistical language model.

The statistical language models corresponding to each intention in the task are constructed by performing a probability estimation for texts for learning generated from the descriptive grammar models indicating each intention in the task with the statistical technique, as described above. On the contrary, the absorbing statistical language model is constructed by generally performing a probability estimation for corpuses collected from web sites or the like with the statistical technique.

Here, the statistical language model is, for example, an N-gram model which causes a probability p (Wᵢ|W₁, . . . , Wᵢ₋₁) in which a word Wᵢ appears in the order of i-th after an (i−1)-th word appears in the order of W₁, . . . , and Wᵢ₋₁ to approximate to the sequence ratio p of the nearest N number of words (Wᵢ|W_{i-N+1}, . . . , Wᵢ₋₁) (as described before). When the content of an utterance by a speaker indicates an intention in a focused task, a probability p^{(k)}(Wᵢ|W_{i-N+1}, . . . , Wᵢ₋₁) obtained from a statistical language model k obtained by learning a text for learning that has the intention has a high value, and intentions 1 to N in the focused task can be accurately grasped (where, k is an integer from 1 to N).

On the other hand, the absorbing statistical language model is created by using general corpuses including an enormous amount of sentences collected from, for example, web sites, and is a spontaneous utterance language model (spoken language model) composed of a larger amount of vocabularies than the statistical language models having each intention in the task.

The absorbing statistical language model contains vocabularies indicating an intention in a task, but when a language score is calculated for the content of an utterance having an intention in a task, the statistical language model having an intention in a task has a higher language score than the spontaneous utterance language model does. That is because the absorbing statistical language model is a spontaneous utterance language model and has a larger amount of vocabularies than each of the statistical language models in which the intentions are specified, and therefore, the appearance probability of a vocabulary having a specific intention is necessarily low.

On the contrary, when the content of an utterance by a speaker is not relevant to a focused task, a probability in which a sentence similar to the content of the utterance exists in a text for learning that specifies an intention. For this reason, a probability in which a sentence similar to the content of the utterance exists in a general corpus is relatively high. In other words, a language score obtained from an absorbing statistical language model obtained by learning a general corpus is relatively higher than a language score obtained from any statistical language model obtained by learning a text for learning that specifies an intention. In addition, it is possible to prevent instances where any intention is forced to fit to the content of an utterance inconsistent with a task by outputting “others” as a corresponding intention from the decoder 15.

FIG. 8 illustrates an operative example when a speech recognition device according to the present embodiment performs a meaning estimation for the task “operate the television”

When the input content of an utterance indicates any intention in the task “operate the television” such as “change the channel”, “watch the program”, or the like, the corresponding intention in the task can be searched in the decoder 15 based on the an acoustic score calculated by the acoustic score calculating section 12 and a language score calculated by the language score calculating section 13.

On the contrary, when the input content of an utterance does not indicate an intention in the task “operate the television” as “it's time to go to the market”, the probability value obtained with reference to the absorbing statistical language model is expected to be the highest, and the decoder 15 obtains the intention of “others” as a search result.

The speech recognition device according to the present embodiment does not employ any statistical language model in a task but uses an absorbing statistical language model even when the content of an utterance irrelevant to the task is recognized, by applying the absorbing statistical language model composed of the spontaneous utterance language model or the like to the language model database 17, in addition to the statistical language models corresponding to each intention in a task, and therefore the risk of erroneously extracting an intention can be reduced.

A series of the processes described above can be executed with hardware, and also with software. In the case of using the latter, for example, a speech recognition device can be realized in a personal computer executing a predetermined program.

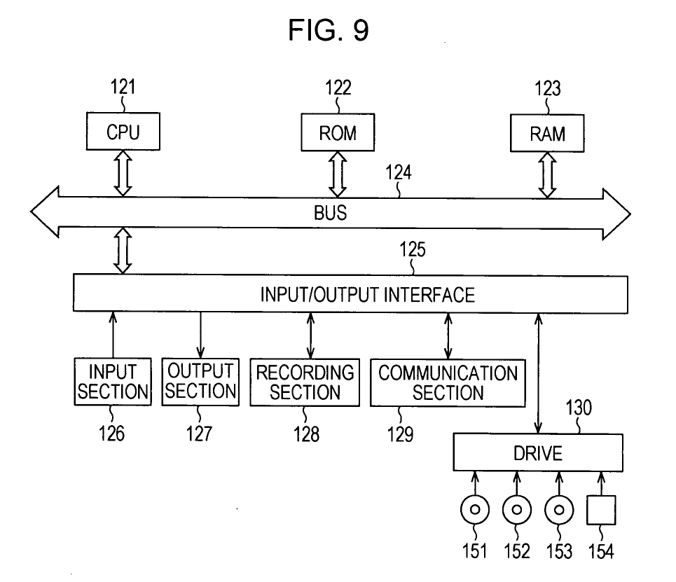

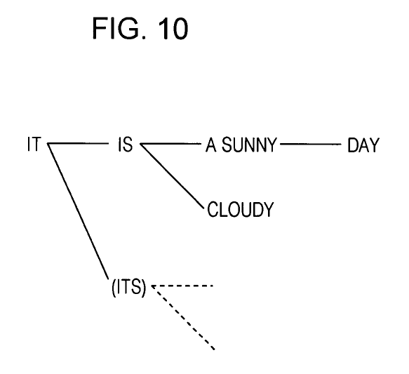

FIG. 9 illustrates a structural example of the personal computer provided in an embodiment of the present invention. A central processing unit (CPU) 121 executes various kinds of processes following a program recorded in a read only memory (ROM) 122, or a recording unit 128. Processing executed following the program includes a speech recognition process, a process of creating a statistical language model used in speech recognition processing, and a process of creating learning data used in creating the statistical language model. Details of each process are as described above.

A random access memory (RAM) 123 properly stores the program that the CPU 121 executes and data. The CPU 121, ROM 122, and RAM 123 are connected to one another via a bus 124.

The CPU 121 is connected to an input/output interface 125 via the bus 124. The input/output interface 125 is connected to an input unit 126 including a microphone, a keyboard, a mouse, a switch, and the like, and an output unit 127 including a display, a speaker, a lamp, and the like. In addition, the CPU 121 executes various kinds of processing according to a command input from the input unit 126.

The recording unit 128 connected to the input/output interface 125 is, for example, a hard disk drive (HDD), and records a program to be executed by the CPU 121 or various kinds of computer files such as processing data. A communicating unit 129 communicates with an external device (not shown) via a communication network such as the Internet or other networks (any of which is not shown). In addition, the personal computer may acquire program files or download data files via the communicating unit 129 in order to record them in the recording unit 128.

A drive 130 connected to the input/output interface 125 drives a magnetic disk 151, an optical disk 152, a magneto-optical disk 153, a semiconductor memory 154, or the like when they are installed therein, and acquires a program or data recorded in such storage regions. The acquired program or data is transferred to the recording unit 128 to be recorded if necessary.

When a series of processing is made to be executed with software, a program constituting the software is installed in a computer incorporated into dedicated hardware or a general personal computer installed with various programs that enables the execution of various functions, from a recording medium.

As shown in FIG. 9, the recording medium includes a magnetic disk 151 where a program is recorded (including a flexible disk), an optical disk 152 (including compact disc-read only memory (CD-ROM) and, a digital versatile disc (DVD)), a magneto-optical disk 153 (including Mini-Disc (MD) as a trademark), or package media including a semiconductor memory 154 or the like, which are distributed to provide users with programs, in addition to the ROM 122 in which a program is recorded, a hard disk included in the recording unit 128 or the like, which are provided for the users in a state of being incorporated into a computer in advance, different from the computers described above.

Furthermore, a program for executing a series of processes described above may be installed in a computer via a wired or wireless communication medium such as a local area network (LAN), the Internet, or digital satellite broadcasting through an interface such as a router or a modem or the like if necessary.

The present application contains subject matter related to that disclosed in Japanese Priority Patent Application JP 2009-070992 filed in the Japan Patent Office on Mar. 23, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A speech recognition device, comprising:
one intention extracting language model and more in which each intention of a focused specific task is inherent;
an absorbing language model in which any intention of the task is not inherent;
a language score calculating section that calculates a language score indicating a linguistic similarity between each of the intention extracting language model and the absorbing language model, and the content of an utterance; and
a decoder that estimates an intention in the content of an utterance based on a language score of each of the language models calculated by the language score calculating section.

2. The speech recognition device according to claim 1, wherein the intention extracting language model is a statistical language model obtained by subjecting learning data, which are composed of a plurality of sentences indicating the intention of the task, to a statistical processing.

3. The speech recognition device according to claim 1, wherein the absorbing language model is a statistical language model obtained by subjecting an enormous amount of learning data, which are irrelevant to indicating the intention of the task or are composed of spontaneous utterances, to a statistical processing.

4. The speech recognition device according to claim 2, wherein the learning data for obtaining the intention extracting language model are composed of sentences which are generated based on a descriptive grammar model indicating a corresponding intention and consistent with the intention.

5. A speech recognition method, comprising the steps of:
firstly calculating a language score indicating a linguistic similarity between one intention extracting language model and more in which each intention of a focused specific task is inherent and the content of an utterance;
secondly calculating a language score indicating a linguistic similarity between an absorbing language model in which any intention of the task is not inherent and the content of an utterance; and
estimating an intention in the content of an utterance based on a language score of each of the language models calculated in the first and second language score calculations.

6. A language model generation device, comprising;
a word meaning database in which a combination of an abstracted vocabulary of a first part-of-speech string and an abstracted vocabulary of a second part-of-speech string and one or more words indicating the same meaning or a similar intention of the abstract vocabularies are registered, by making abstract the vocabulary candidate of the first part-of-speech string and the vocabulary candidate of the second part-of-speech string that may appear in an utterance indicating an intention, with respect to each intention of a focused specific task;
descriptive grammar model creating means for creating a descriptive grammar model indicating an intention based on the combination of the abstracted vocabulary of the first part-of-speech string and the abstracted vocabulary of the second part-of-speech string indicating the intention of the task and one or more words indicating a same meaning or a similar intention for abstract vocabularies registered in the word meaning database;
collecting means for collecting a corpus having a content that a speaker is likely to utter for an intention by automatically generating sentences consistent with each intention from the descriptive grammar model for the intention; and
language model creating means for creating a statistical language model in which each intention is inherent by subjecting the corpus collected for the intention to statistical processing.

7. The language model generation device according to claim 6, wherein the word meaning database has the abstracted vocabulary of the first part-of-speech string and the abstracted vocabulary of the second part-of-speech string arranged on a matrix for each string and has a mark indicating the existence of the intention given in a column corresponding to the combination of the vocabulary of the first part-of-speech and the vocabulary of the second part-of-speech having intentions.

8. A language model generation method, comprising the steps of:
creating a grammar model by making abstract a necessary phrase for transmitting each intention included in a focused task;
collecting a corpus having a content that a speaker is likely to utter for an intention by automatically generating sentences consistent with each intention by using the grammar model; and
constructing a plurality of statistical language models corresponding to each intention by performing probabilistic estimation from each corpus with a statistical technique.

9. A computer program described in a computer readable format so as to execute a process for speech recognition on a computer, the program causing the computer to function as:
one intention extracting language model and more in which each intention of a focused specific task is inherent;
an absorbing language model in which any intention of the task is not inherent;
a language score calculating section that calculates a language score indicating a linguistic similarity between each of the intention extracting language model and the absorbing language model, and the content of an utterance; and
a decoder that estimates an intention in the content of an utterance based on a language score of each of the langue models calculated by the language score calculating section.

10. A computer program described in a computer readable format so as to execute a process for the generation of a language model on a computer, the program causing the computer to function as:
a word meaning database in which a combination of an abstracted vocabulary of a first part-of-speech string and an abstracted vocabulary of a second part-of-speech string and one or more words indicating the same or a similar intention of the abstract vocabularies are registered, by making abstract the vocabulary candidate of the first part-of-speech string and the vocabulary candidate of the second part-of-speech string that may appear in an utterance indicating an intention, with respect to each intention of a focused specific task;
descriptive grammar model creating means for creating a descriptive grammar model indicating an intention based on the combination of the abstracted vocabulary of the first part-of-speech string and the abstracted vocabulary of the second part-of-speech string indicating the intention of the task and one or more words indicating a same meaning or a similar intention for abstract vocabularies registered in the word meaning database;
collecting means for collecting a corpus having a content that a speaker is likely to utter for an intention by automatically generating sentences consistent with each intention from the descriptive grammar model for the intention; and
language model creating means for creating a statistical language model in which each intention is inherent by subjecting the corpus collected for the intention to statistical processing.

11. A language model generation device, comprising;
a word meaning database in which a combination of an abstracted vocabulary of a first part-of-speech string and an abstracted vocabulary of a second part-of-speech string and one or more words indicating the same meaning or a similar intention of the abstract vocabularies are registered, by making abstract the vocabulary candidate of the first part-of-speech string and the vocabulary candidate of the second part-of-speech string that may appear in an utterance indicating an intention, with respect to each intention of a focused specific task;
a descriptive grammar model creating unit which creates a descriptive grammar model indicating an intention based on the combination of the abstracted vocabulary of the first part-of-speech string and the abstracted vocabulary of the second part-of-speech string indicating the intention of the task and one or more words indicating a same meaning or a similar intention for abstracted vocabularies registered in the word meaning database;
a collecting unit which collects a corpus having a content that a speaker is likely to utter for an intention by automatically generating sentences consistent with each intention from the descriptive grammar model for the intention; and
a language model creating unit that creates a statistical language model in which each intention is inherent by subjecting the corpus collected for the intention to statistical processing.
